(19) United States
(12) Patent Application Publication
(10) Pub. No.: US 2004/0175540 A1
(43) Pub. Date: Sep. 9, 2004

(54) Incombustible duct hose and method for manufacturing the same

(75) Inventors: Kouki Fukui, Osaka (JP); Isao Kurimoto, Osaka (JP); Masahiko Ogake, Osaka (JP)

Correspondence Address: MCGINN & GIBB, PLLC, 8321 OLD COURTHOUSE ROAD, SUITE 200, VIENNA, VA, 22182-3817, US

(73) Assignee: Totaku Industries, Inc., Osaka (JP)

(21) Appl. No.: 10/793,211

(22) Filed: Mar. 5, 2004

(30) Foreign Application Priority Data
Mar. 6, 2003 (JP) P.2003-059538

(51) Int. Cl. F16L 1/00

(52) U.S. Cl. 428/122; 428/36.9

(57) ABSTRACT

In an incombustible duct hose, a cloth material with a predetermined width is spirally wound to form a cylindrical shape, and a metal strip-like material caulks adjacent side edge portions of the spirally-wound cloth material to connect them. The cloth material is fabricated in a gas impermeable state by coating a silicone at least on one surface of a silica cloth sheet so that a texture of the silica cloth sheet is clogged by the coated silicone. The silicone is subjected to a fire retardant treatment by mixing a flame retardant.

### BACKGROUND OF THE INVENTION

1. Field of the Invention

The present invention relates to an incombustible duct hose and a method for manufacturing an incombustible duct hose excellent in heat resistance suitable for being used as a duct hose for exhausting smoke or a duct hose for drying grain or the like.

2. Description of the Related Art

In a related art, a duct hose having heat resistance of this kind has variously been researched and variously proposed. As one of the duct hoses having heat resistance, there is a duct hose using a glass cloth sheet as a cloth for forming a hose wall, and a surface of the glass cloth sheet is coated by a silica. Further, as described in, for example, Japanese Publication JP-A-9-222184, there is a duct hose using a sheet with a three-layered shape as a hose wall member, and the sheet is formed by sandwiching a thin layer of a mica by two sheets of silica cloths.

According to the related-art duct hoses, in the case of the former duct hose using the glass cloth sheet, it is known that when the duct hose is exposed to high temperature of several hundreds ° C., a glass material constituting a main material of the cloth is melted. Therefore, pores are formed at a hose wall of the duct hose in accordance with the melting, and the pores are gradually enlarged. Accordingly, there poses a problem that the duct hose is not suitable for being used at a place having a danger of being exposed to high temperature equal to or higher than several hundreds ° C., and thus the duct hose cannot be used with security.

Further, in the case of the latter duct hose using the three-layered sheet constituting the mica being sandwiched with the silica cloths, when the three-layered sheet is wound in a spiral shape in forming the duct hose, the mica layer is broken. Further, also in piping, the mica layer is broken at a bent portion and the layered state is liable to be difficult to maintain. Therefore, the related art poses a problem in that it is difficult to reduce the breathability of the related art silica cloth itself by the related art mica layer. Thus, gas tightness of the duct hose cannot be guaranteed.

### SUMMARY OF THE INVENTION

It is an object of the present invention to provide an incombustible duct hose and a method for manufacturing an incombustible duct hose by using a novel cloth material for forming a hose wall. The incombustible duct hose of the present invention has a fire retardant property which can sufficiently resists high temperature without being burned and without emitting a poisonous gas even exposed to high temperature at 800° C. or higher. The incombustible duct hose of the present invention is light-weighted and is facilitated in transportation and piping thereof without bringing about any breaking phenomenon at the cloth material in bending the duct hose, and can maintain gas tightness over a long period of time

In order to accomplish the object above, the following means are adopted. According to the present invention, there is provided an incombustible duct hose according to the present invention, comprising:

a cloth material being spirally wound to form a cylindrical shape; and

a metal strip-like material for caulking and connecting a side edge portion of the spirally-wound cloth material with an adjacent side edge portion of an adjacent spirally wound cloth material,

wherein the cloth material is a gas impermeable silica cloth sheet with a flame retarding silicone on at least one surface thereof.

The above-mentioned object can also be achieved by an incombustible duct hose, according to the present invention, comprising:

a cloth material being spirally wound to form a cylindrical shape; and

a metal strip-like material for caulking adjacent side edge portions of the spirally-wound cloth material to connect them,

wherein the cloth material is formed in a gas impermeable state, in accordance with a manner that at least one surface of a silica cloth sheet is coated with silicone, which is flame proof finished by mixing with a flame retardant.

The present invention is constructed by the above-mentioned structure. The present invention can be embodied by constituting the cloth material 1 in the gas impermeable state which is fabricated by coating the silicone subjected to the fire retardant treatment on both of a front surface and a rear face of the silica cloth sheet so that the texture of the silica cloth sheet is clogged. Further, means for coating the silicone subjected to the fire retardant treatment onto the silica cloth sheet does not signify only coating means as in brush coating in narrow meaning but is intended to include press coating means by a roller or the like as in textile printing or coating means by mist blow means as in a coating method or other pertinent means. In sum, means for coating the silicone subjected to the fire retardant treatment onto the silica cloth sheet designates means for fabricating the cloth material 1 in the gas impermeable state such that a phenomenon of leaking out a gas from the texture is not brought about by clogging the texture of the silica cloth sheet by the silicone subjected to the fire retardant treatment.

### BRIEF DESCRIPTION OF THE DRAWINGS

FIG. 1 is an external view showing an incombustible duct hose of a first embodiment of the invention;

FIG. 2 is a view of a cut end face vertically cutting to show a hose wall of FIG. 1;

FIG. 3 is a view of a cut end face enlarging to show a portion of FIG. 2;

FIG. 4 is an external view in correspondence with FIG. 1 showing an incombustible duct hose of a second embodiment;

FIG. 5 is a view of a cut end face vertically cutting to show a hose wall of FIG. 4;

FIG. 6 is a view of a cut end face enlarging to show a portion of FIG. 5; and

FIG. 7 is a view of a cut end face enlarging to show other embodiment.

### DETAILED DESCRIPTION OF THE INVENTION

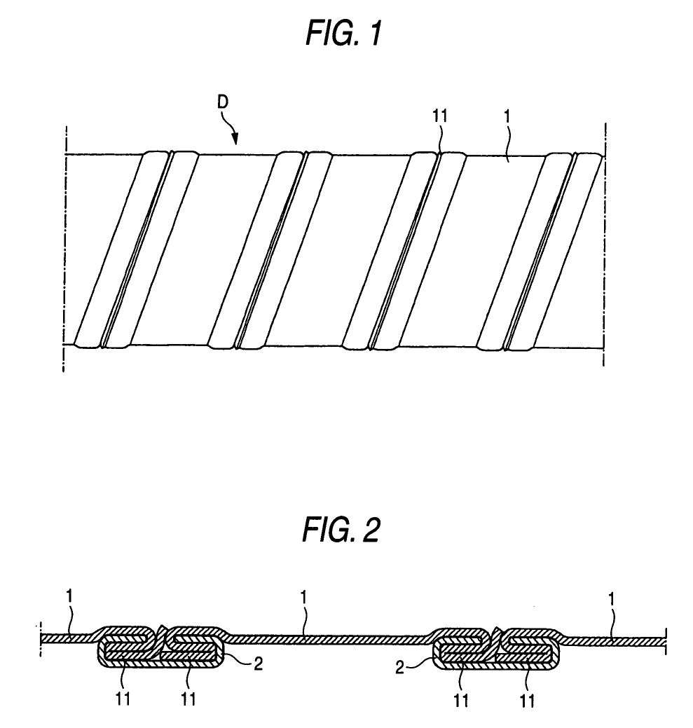

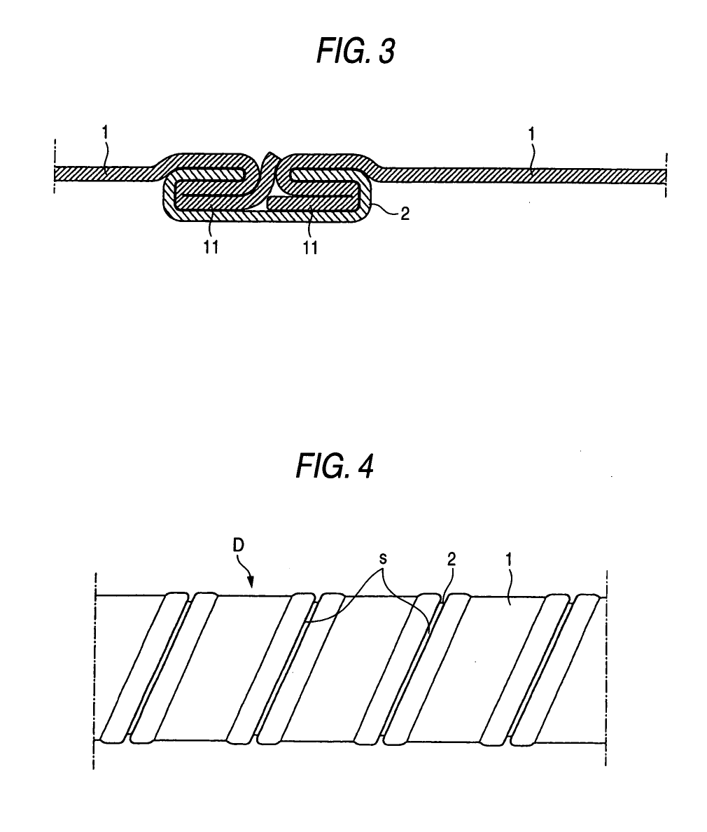

Embodiments of the invention will be explained in reference to the drawings as follows. FIG. 1 through FIG. 3 of the drawings are views showing an incombustible duct hose of a first embodiment of the invention. FIG. 1 is a front view showing an exterior appearance of a duct hose, FIG. 2 is a view of an end face cutting to show a hose wall portion of the duct hose and FIG. 3 is an explanatory view enlarging to show a connection portion of a hose wall in FIG. 2.

According to a duct hose D shown in the first embodiment, as a material for forming a hose wall, there is used a cloth material 1 fabricated in a gas impermeable state such that a gas does not flow through a texture by forming silicone films on both surfaces (front surface and rear surface) of a silica cloth sheet. The silicone films are formed by coating a silicone, which is subjected to a fire retardant treatment by mixing a flame retardant, on both surfaces of the silica cloth sheet. The texture of the silica cloth sheet is clogged by the silicone subjected to the fire retardant treatment. The silica cloth sheet is formed by weaving silica fiber yarns by satin weave.

The cloth material 1 has a strip-like shape with a predetermined width (in this case, a spiral pitch width+a width of a folded-back portion for caulk connection) The cloth material 1 is formed in a cylindrical shape as shown in FIGS. 1 and 2, by spirally winding the cloth material 1 while folding back adjacent side edge portions 11, 11 and performing a caulk connection for the folded-back portions of the adjacent side edge portions 11, 11 by a strip-like material 2. The strip-like material 2 is made of stainless steel and is bent to have a section substantially in a C-like shape. In more detail, the side edge portion 11 on a succeeding winding side of the cloth material 1 precedingly wound in the spiral shape and the adjacent side edge portion 11 on a preceding winding side of the cloth material 1 succeedingly wound in the spiral shape are respectively folded back in an S-like shape as seen in FIGS. 2 and 3. Then, the folded-back portions of the adjacent side edge portions 11, 11 are sandwiched by the strip-like material 2 and pressed to flatten so that the caulk connection is performed.

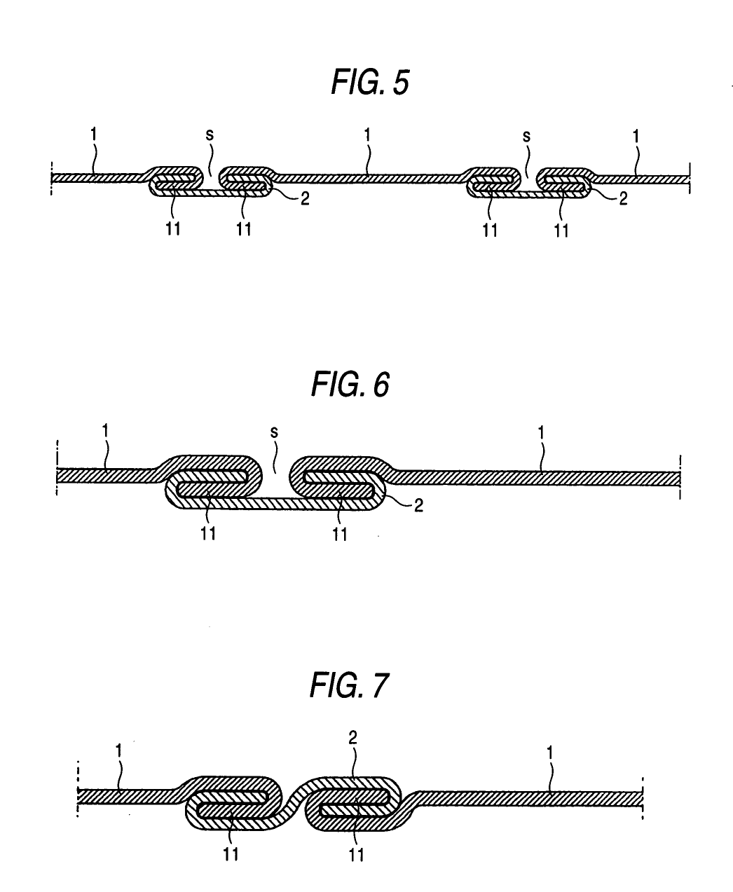

Next, a second embodiment shown in FIG. 4 through FIG. 6 will be explained. FIG. 4, FIG. 5 and FIG. 6 are views respectively in correspondence with FIG. 1, FIG. 2 and FIG. 3 shown in the above-described first embodiment.

According to a duct hose D shown in the second embodiment, similar to the case of the first embodiment, as a material for forming the hose wall, there is used the cloth material 1 fabricated in the gas impermeable state by coating a silicone, which is made fire-proof by mixing a flame retardant with a fire retardant treatment, on both surfaces of the silica cloth sheet, which is formed by weaving the silica fiber yarns by satin weave. A point of the second embodiment which differs from the first embodiment is that as shown by FIG. 5 and FIG. 6, the shape of both side edge portions 11, 11 of the cloth material 1 sandwiched by the metal strip-like material 2 is constituted by folding back the cloth material 1 in a U-like shape. Further, the duct hose D shown in the second embodiment is constructed as a structure in which there is a gap portion s at which the cloth material 1 is not present between folded-back portions of the cloth material 1 folded back in the U-like shape, that is, the gap portion s comprising only the metal strip-like material 2.

It is not necessarily needed that the cloth material of the duct hose D according to the invention covers an entire face of the duct hose without gap, as in the first embodiment. As shown in the second embodiment, the duct hose D may be constituted by using the metal strip-like material 2 connecting the cloth material as a portion of the hose wall as well as the cloth material.

Although an explanation has been given of the embodiments of the invention which are regarded to be representative as described above, the invention is not necessarily limited to the structures shown in the embodiments and the invention can pertinently be modified to embody within the range achieving the object of the invention and having an effect as follows. For example, as shown in FIG. 7, the adjacent side edge portions 11, 11 of the cloth material 1 may be caulked by the metal strip-like material 2 having a section formed in an S-like shape to connect the adjacent side edge portions 11, 11. Further, although in the first and second embodiments, the silicone is coated on both surfaces of the silica cloth sheet, the silicone may be coated on one surface of the silica cloth sheet.

As has already been apparent from the above-described explanation, according to the invention, the material for forming the hose wall is constituted by the cloth material. The cloth material is fabricated in the gas impermeable state by coating a silicone, which is subjected to the fire retardant treatment, on both surfaces of the silica cloth sheet so that the texture of the silica cloth sheet is clogged. The duct hose is formed by the above-described novel and non-obvious cloth material. Therefore, there is achieved a remarkable effect of capable of maintaining the cylindrical shape capable of sufficiently resisting high temperature even exposed to high temperature at, for example, 800° C. or higher without producing burning flame and without being melted to bring about a perforating phenomenon, further, without emitting a poisonous gas even exposed to the high temperature.

In addition thereto, the material forming the hose wall is constituted by one sheet of the cloth material. Therefore, there is also achieved an effect in which a total of the duct hose is light-weighted and transportation or piping thereof can easily be carried out, the hose can be bent freely, and the gas tightness can be maintained over a long period of time without bringing about any broken phenomenon at the cloth material even at the bent portion.

What is claimed is:

1. An incombustible duct hose comprising:
a cloth material being spirally wound to form a cylindrical shape; and
a metal strip-like material for caulking and connecting a side edge portion of the spirally-wound cloth material with an adjacent side edge portion of an adjacent spirally wound cloth material,
wherein the cloth material is a gas impermeable silica cloth sheet with a flame retarding silicone on at least one surface thereof.

2. The incombustible duct hose according to claim 1, wherein said flame retarding silicone is a-silicone mixed with flame retardant.

3. The incombustible duct hose according to claim 1, wherein said gas impermeable silica cloth sheet is coated with the flame retarding silicone on the surface thereof so as to make the texture of the cloth sheet clogged.

4. The incombustible duct hose according to claim 1, wherein said surface comprises a front surface and a rear surface of the silica cloth sheet.

5. The incombustible duct hose according to claim 2, wherein said surface comprises a front surface and a rear surface of the silica cloth sheet.

6. The incombustible duct hose according to claim 3, wherein said surface comprises a front surface and a rear surface of the silica cloth sheet.

7. A method for manufacturing an incombustible duct hose, the method comprising:
fabricating a cloth material by forming a silica cloth sheet, coating at least one surface of said silica cloth sheet with silicone that has been treated with a flame retardant;
spirally winding the cloth material to form a cylindrical shape; and
caulking and connecting a side edge portion of the spirally-wound cloth material with an adjacent side portion of an adjacent sprirally wound cloth material by a metal strip-like material.

8. The method for manufacturing the incombustible duct hose according to claim 7, wherein said silica cloth sheet is coated with the silicone on the surface thereof so as to make the texture of the cloth sheet clogged.

9. The method for manufacturing the incombustible duct hose according to claim 7, wherein said surface comprises a front surface and a rear surface of the silica cloth sheet.

10. The method for manufacturing the incombustible duct hose according to claim 8, wherein said surface comprises a front surface and a rear surface of the silica cloth sheet.
